(19) United States
(12) Patent Application Publication
(10) Pub. No.: US 2016/0175985 A1
(43) Pub. Date: Jun. 23, 2016

(54) SYSTEM AND METHOD FOR LASER CLADDING

(71) Applicant: Caterpillar Inc., Peoria, IL (US)

(72) Inventors: Tomasz J. Chojnacki, Peoria, IL (US); Daniel J. Sordelet, Peoria, IL (US)

(73) Assignee: Caterpillar Inc., Peoria, IL (US)

(21) Appl. No.: 14/577,009

(22) Filed: Dec. 19, 2014

(51) Int. Cl. B23K 26/34; B23K 26/12

(52) U.S. Cl. CPC B23K 26/34; B23K 26/12

(57) ABSTRACT

A method for applying a cladding layer to a substrate is provided. The method includes applying a cladding layer from a start position using a laser operating in a continuous mode of operation. The method also includes completing the cladding layer at a stop position that is in close proximity to the start position. The area between the start position and the stop position defines a gap. The method further includes applying the laser directly to at least the gap while operating in a pulse mode of operation and filling the gap with an overlap cladding layer using the laser operating in the continuous mode of operation.

### TECHNICAL FIELD

The present disclosure relates to a system and method for applying a cladding layer on a substrate using a laser.

### BACKGROUND

Laser cladding process for a substrate may be used for a variety of applications such as a surface treatment technology, imparting properties such as wear resistance and the like. The laser cladding process may include supplying a clad material at a location at which a laser is irradiated to obtain a clad layer. Typically, a solidification time for the clad material to form the clad layer may be extended to reduce cracks. However, in some cases, oxides may be formed due to prolonged exposure of a hot zone to the atmosphere. These oxides may lead to defects in the clad layer.

Conventional methods that have been implemented to remove the oxides include addition of flux, grit blasting or grinding. For reference, J. P patent no 2009061491 discloses a method for laser build-up welding, which forms a build-up layer on a metal base body by irradiation of a laser beam. The method also quickly melts a metal member for build-up welding by irradiation of a laser beam and rapidly certainly forms a build-up layer on a metal base body. In the method for laser build-up welding, a metal member 3 for build-up welding is previously fixed onto a metal base body 2. Thereafter, the metal member 3 for build-up welding is irradiated with a laser beam b and melted, so that a build-up layer 4 is formed on the metal base body 2.

### SUMMARY OF THE DISCLOSURE

In one aspect of the present disclosure, a method for applying a cladding layer to a substrate is provided. The method includes applying a cladding layer from a start position using a laser operating in a continuous mode of operation. The method also includes completing the cladding layer at a stop position that is in close proximity to the start position. The area between the start position and the stop position defines a gap. The method further includes applying the laser directly to at least the gap while operating in a pulse mode of operation and filling the gap with an overlap cladding layer using the laser operating in the continuous mode of operation.

In another aspect of the present disclosure, the method for applying the cladding layer to the substrate is a computer-implemented method.

In yet another aspect of the present disclosure, a system for applying a cladding layer to the substrate is provided. The system includes a laser head configured to generate a laser, a dispensing apparatus configured to dispense a cladding material. The system also includes a controller communicably coupled to the laser head and the dispensing apparatus. The controller is configured to apply a cladding layer from a start position using the laser operating in a continuous mode of operation. The controller is also configured to complete the cladding layer at a stop position that is in close proximity to the start position. Further, the area between the start position and the stop position defines a gap. The controller is further configured to apply the laser directly to at least the gap while operating in a pulse mode of operation and fill the gap with an overlap cladding layer using the laser operating in the continuous mode of operation.

### BRIEF DESCRIPTION OF THE DRAWINGS

FIG. 1 is a block diagram of a system for applying a cladding layer to an exemplary substrate;

FIG. 2 is a flowchart for a method of applying a cladding layer to the substrate, according to an embodiment of the present disclosure;

FIG. 3 is a top view and a partial front view of the substrate showing a start position, according to an embodiment of the present disclosure;

FIG. 4 is a top view and a partial front view of the substrate showing a stop position and a cladding layer on the substrate, according to another embodiment of the present disclosure;

FIG. 5 is a top view and a partial front view of the substrate showing a laser being applied directly to a gap, according to an embodiment of the present disclosure; and

FIG. 6 is a top view and a partial front view of the substrate showing an overlap cladding layer, according to an embodiment of the present disclosure.

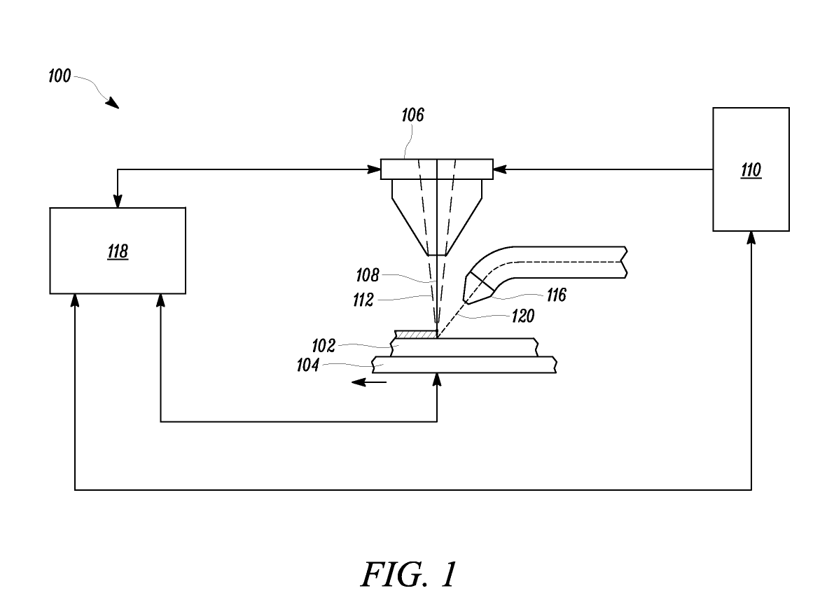

### DETAILED DESCRIPTION

Wherever possible, the same reference numbers will be used throughout the drawings to refer to the same or the like parts. Referring to FIG. 1, a block diagram of a system 100 configured to apply a cladding layer to an exemplary substrate 102 is illustrated. The substrate 102 may be disposed on a work stage 104.

The system 100 includes a laser head 106. The laser head 106 may be configured to irradiate a laser 108 onto the substrate 102. Accordingly, the laser head 106 may include a laser emitting unit, an oscillating unit, an optical element such as an, optical fibre and a focussing unit. The components of the laser head 106 are known in the art and not shown in FIG. 1 for illustrative purposes. The oscillating unit may be configured to oscillate the laser 108 at a specified frequency. The laser 108 at the specified frequency may be transmitted through the optical element to the laser focusing unit. At the focusing unit, the laser 108 may be focused, and irradiated to the substrate 102 via the laser emitting unit. Further, the laser 108 may operate in different modes such as, a continuous mode of operation and a pulse mode of operation based on the frequency of the laser 108. The laser 108 in the continuous mode of operation may be pulsed at a pre-determined frequency to obtain the laser 108 in the pulse mode of operation. In an example, the laser 108 in the pulse mode of operation may have a frequency of the order of 10 milliseconds.

The system 100 also includes a dispensing apparatus 110 that is configured to deliver a stream 112 of cladding material to the substrate 102. Further, the dispensing apparatus 110 may include multiple feeding tubes (not shown) through which the cladding material may be delivered. In one example, the feeding tubes may be coupled to the laser head 106 so as to supply the cladding material from the dispensing apparatus 110. In such a case, the laser head 106 may deliver the stream 112 of the cladding material received from the dispensing apparatus 110 onto the substrate 102. In another example, the feeding tubes may be configured to directly deliver the stream 112 of the cladding material to the substrate 102. However, in various other examples, the dispensing apparatus 110 and the laser head 106 may have other configurations known in the art.

Specifically, the dispensing apparatus 110 may deliver the stream 112 of cladding material to the substrate 102 at a location at which the laser 108 impinges upon the substrate 102. The laser 108 may act as a source of heat which in turn melts the cladding material on the substrate 102 to form a fusion bond between the substrate 102 and a molten cladding material lying thereupon. As such, the cladding layer may be applied to the substrate 102 via the system 100.

Further, the laser head 106 and the substrate 102 may be configured to have a relative velocity with respect to each other. As such, the cladding layer may be applied on a desired area of the substrate 102. In one embodiment, the relative velocity may be due to a movement of the laser head 106. For example, the laser head 106 may be mounted on a robotic arm that facilitates the desired movement. In another embodiment, the relative velocity may be due to a movement of the substrate 102. For example, the substrate 102 may be disposed on the work stage 104 that is movable. In yet another embodiment, both the laser head 106 and the substrate 102 may move relative to each other. Accordingly, the laser head 106 and/or the substrate 102 may be coupled or disposed on different auxiliary components known in the art to facilitate the relative velocity between the laser head 106 and the substrate 102.

In an embodiment, the system 100 also includes a nozzle 116 configured to provide a shielding gas 120 to the substrate 102. Further, the shielding gas 120 may be provided around the location at which the stream 112 of the cladding material flows. In an example, the shielding gas 120 may be any inert gas such as, argon or helium and the like.

The system 100 further includes a controller 118. The controller 118 may embody a single microprocessor or multiple microprocessors configured for receiving signals from the components of the system 100. Numerous commercially available microprocessors may be configured to perform the functions of the controller 118. A person of ordinary skill in the art will appreciate that the controller 118 may additionally include other components and may also perform other functions not described herein.

The controller 118 may be communicably coupled to the laser head 106. The controller 118 may be configured to operate the laser 108 in different modes of operation such as, the continuous mode of operation and the pulse mode of operation. Further, the controller 118 may also be configured to switch the operation of the laser 108 between the continuous mode of operation and the pulse mode of operation. Additionally, the controller 118 may be configured to receive signals indicative of movement of the laser head 106.

The controller 118 may also be communicably coupled to the dispensing apparatus 110. Moreover, the controller 118 may be configured to provide signals corresponding to starting and/or stopping the dispensing apparatus 110 from delivering the stream 112 of the cladding material to the substrate 102.

In an embodiment, the controller 118 may also be communicably coupled to the work stage 104 and/or the substrate 102. The controller 118 may receive information related to movement of the corresponding work stage 104 and/or the substrate 102. Further, the controller 118 may be configured to determine a position of the laser head 106 relative to the substrate 102. Additionally, the controller 118 may also position the laser head 106 and/or the substrate 102 to a pre-determined position. In an example, the controller 118 may provide signal to the work stage 104 indicative of an angle of rotation of the work stage 104.

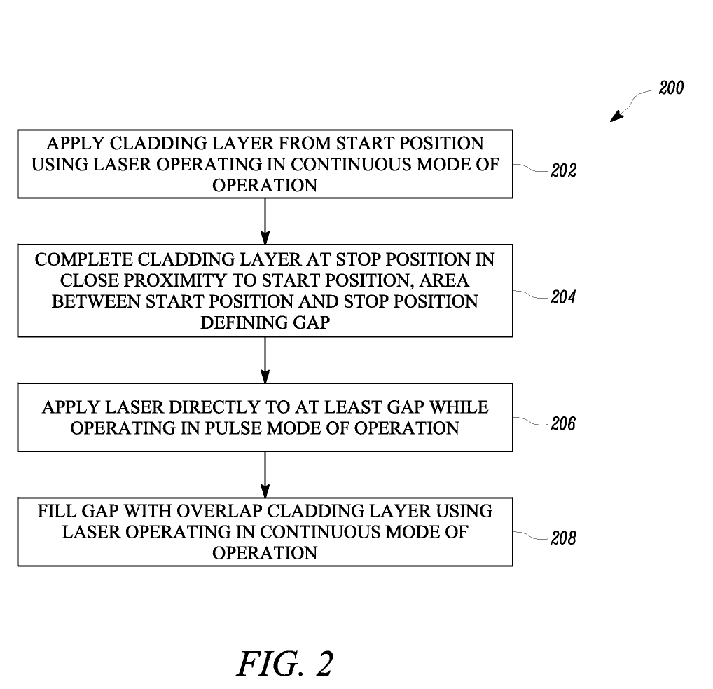

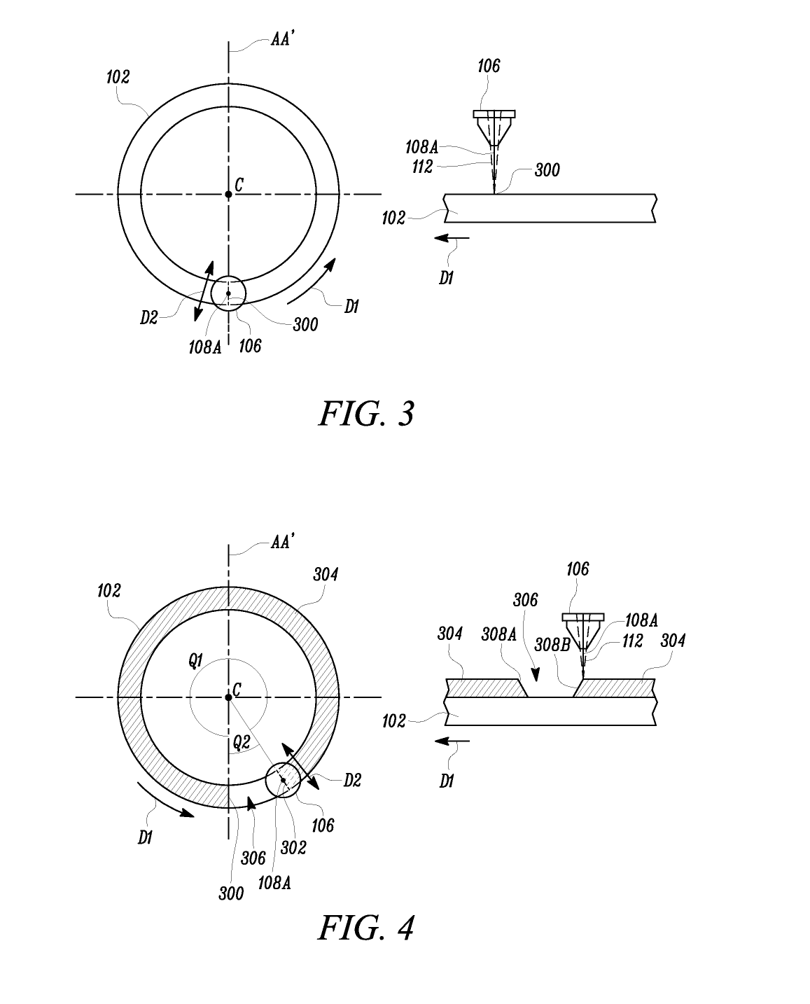

Referring to FIG. 2, a flow chart for a method 200 of applying a cladding layer to the substrate 102 is illustrated. In the illustrated embodiment, the substrate 102 has an annular shape (shown in FIG. 3). In an example, the substrate 102 may be a sealing ring. The substrate 102 defines a reference axis AA′ and a center C. The cladding layer may be applied to a top surface of the substrate 102.

Referring to FIGS. 3 to 6, various steps of the method 200 implemented on the substrate 102 are illustrated. In an embodiment, the method 200 may be a computer-implemented method. The controller 118 of the system 100 may be configured to implement the method 200. The method 200 will be explained hereinafter with reference to FIGS. 3 to 6.

At step 202, the method 200 includes applying a cladding layer 304 from a start position 300 using the laser 108A operating in a continuous mode of operation. The controller 118 may define a reference location on the substrate 102 as the start position 300. In the illustrated embodiment of FIG. 3, the start position 300 may subtend an angle that is approximately zero degrees with the reference axis AA′ of the substrate 102. Accordingly, the laser head 106 may be positioned above the start position 300 on the substrate 102.

Further, at step 202, the laser head 106 and the substrate 102 may move relative to each other. In the illustrated embodiment, the substrate 102 is configured to rotate in a direction D1. In an example, the work stage 104 on which the substrate 102 is disposed may be rotated in the direction D1. Additionally, the laser head 106 may move in a radial direction D2 so as to apply the cladding layer 304 at least partially to the width of the substrate 102.

At step 202, the method 200 includes delivering the stream 112 of the cladding material on the substrate 102 at a location at which the laser 108A impinges upon the substrate 102. The cladding material may be in the form of a powder or a wire. The cladding material may be selected based on type of the cladding process being performed, a material of the substrate 102, a property of the substrate 102 that needs to be improved and the like.

At step 204, the method 200 includes completing the cladding layer 304 at a stop position 302 that is in close proximity to the start position 300. Referring to FIG. 4, the start position 300 and the stop position 302 together subtend an angle Q1 with the centre C of the substrate 102. The angle Q1 may lie in a range of 350 to 359 degrees. Further, the start position 300 and the stop position 302 may be a pre-determined based on a shape, size, configuration and the like for a substrate 102 and other relevant parameters.

In one embodiment, the angle Q1 may be stored in a memory associated with the controller 118. In another embodiment, the angle Q1 may be input to the controller 118 by an operator. In yet another embodiment, the controller 118 may determine the angle Q1 based on a size, shape, of the substrate 102 and other relevant parameters.

The substrate 102 may be rotated to the angle of rotation that is approximately equal to the angle Q1 to complete the cladding layer 304 at the stop position 302. The controller 118 may receive signals indicative of the angle of rotation of the substrate 102. Further, the controller 118 may determine the completion of the cladding layer 304 based on the angle of rotation of the substrate 102.

Further, the area between the start position 300 and the stop position 302 defines a gap 306. The gap 306 may subtend an angle Q2 with the centre C of the substrate 102. The angle Q2 may be substantially equal to (360 degree—angle Q1).

At step 206, the method 200 includes applying the laser 108B directly to at least the gap 306 while operating in a pulse mode of operation. At step 206, the method 200 includes applying the laser 108B directly to a clad ends 308A, 308B of the cladding layer 304 while operating in the pulse mode of operation.

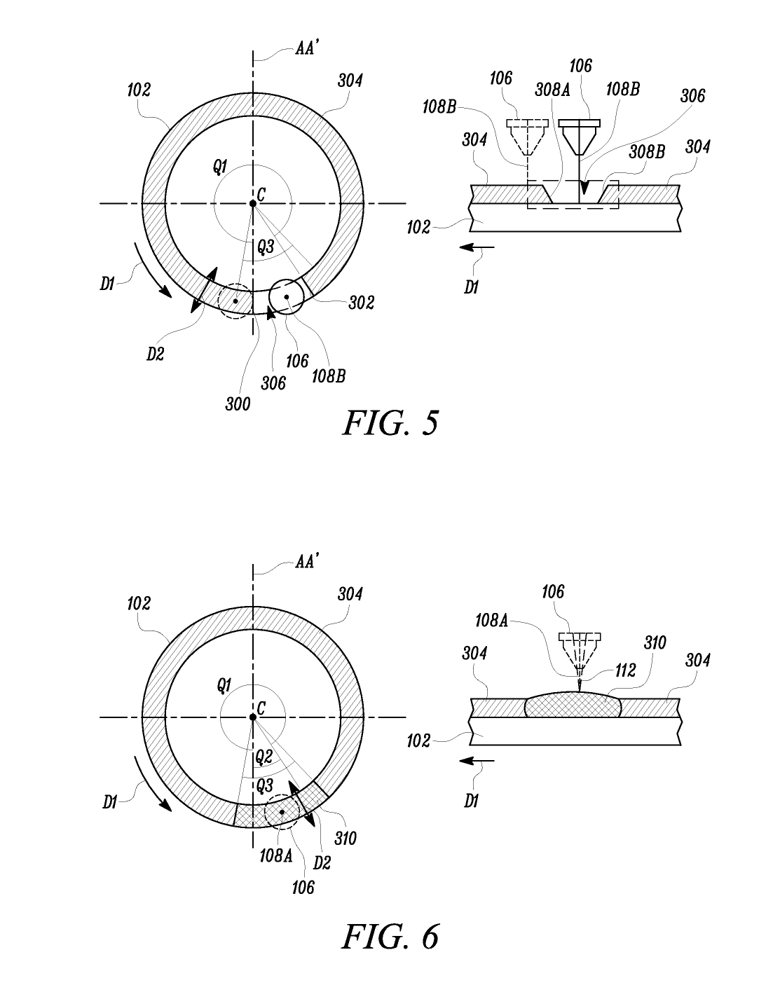

Upon completing the cladding layer 304 at the stop position 302, the controller 118 may be configured to switch the mode of operation of the laser 108 to the pulse mode of operation. The controller 118 may be further configured to stop the dispensing apparatus 110. Subsequently, the laser 108B may be applied directly to the gap 306 by providing a relative rotation between the laser head 106 and the substrate 102. Referring to FIG. 5, the substrate 102 may be rotated further to the angle of rotation that is greater than or equal to the angle Q2 in the direction D1. Further, the laser head 106 may also move in the radial direction D2.

The controller 118 may also apply the laser directly to the clad ends 308A, 308B of the cladding layer 304 at the start position 300 and the stop position 302 respectively. In an embodiment, the controller 118 may additionally apply the laser 108B directly to at least a portion of the cladding layer 304.

In an embodiment, the method 200 may also include performing additional cleaning operations such as, supplying a cleaning agent to the gap 306 on the substrate 102.

At step 208, the method 200 includes filling the gap 306 with an overlap cladding layer 310 using the laser 108A operating in the continuous mode of operation. The overlap cladding layer 310 may extend along the gap 306 and also overlaps a portion of the cladding layer 304. Referring to FIG. 6, the overlap cladding layer 310 may subtend an angle Q3 with the centre of the substrate 102. The angle Q3 may be greater than the angle Q2 subtended by the gap 306 defined between the start and stop positions 300, 302. In an example, the angle Q3 may lie in a range of 2 to 12 degrees.

To implement the step 208, the controller 118 may switch the mode of operation to obtain the laser 108A in the continuous mode of operation. The controller 118 may be further configured to start the operation of the dispensing apparatus 110. Subsequently, the controller 118 may fill the gap 306 with the overlap cladding layer 310 by providing a relative rotation between the laser head 106 and the substrate 102.

In the illustrated embodiment, the substrate 102 may be rotated to an angle Q3 relative to the laser head 106 in the direction D1. Moreover, the substrate 102 may be also be repositioned accordingly to obtain the overlap cladding layer 310 by rotating in the direction D1. For example, upon applying the laser 108B directly to the gap 306, the substrate 102 may be rotated from the start position 300 to an angle substantially equal to (Q2)+((Q3)/2) in a direction opposite to the direction D1.

The method 200 further includes supplying the shielding gas 120 to the substrate 102 at least one the steps 202, 204, 206 and 208. The shielding gas 120 may be supplied via the nozzle 116 around the location at which the laser 108 impinges the substrate 102.

Although, it is shown that the cladding layer is applied to an entire width of the substrate 102, it may be contemplated to apply the cladding layer partially along the width of the substrate 102. Accordingly, a relative movement between the laser head 106 and the substrate 102 along the radial direction D2 may be controlled.

Further, a person of ordinary skill in the art will acknowledge that the substrate 102 described herein is exemplary in nature and hence non-limiting of this disclosure. Therefore, the method 200 and the system 100 may be used to apply a cladding layer to any substrate of different configurations, sizes and the like. In an example, the method 200 and the system 100 may be used for a substrate of rectangular shape. In such a case, a linear motion for example multiple passes, may be provided for the substrate and/or the laser head 106. The gap 306 may be defined between the cladding layers 304 obtained on the substrate during two of the passes.

### INDUSTRIAL APPLICABILITY

The present disclosure relates to the system 100 and the method 200 of applying a cladding layer to the substrate 102. With use of the system 100 and the method 200, the cladding layer 304 is applied between the start and stop positions 300, 302 using the laser 108A operating in the continuous mode of operation.

Subsequently, the laser 108B in the pulse mode of operation is directly applied to the gap 306 between the start and stop positions 300, 302 so as to clean the substrate 102. The laser 108B which is typically in the form of a beam of light, may cause removal of the contaminant for example, oxides from the substrate 102. The cleaning may occur via any mechanism, including one or more of, alone or in any combination, ablation, melting, heating or reaction with the substrate 102 or the contaminant. The optical energy from the laser 108B is typically applied to a selected area of the substrate 102 such as, the gap 306, and the substrate 102 or the laser head 106 are moved relative to one another so as to clean the gap 306 along with the clad ends 308A, 308B.

After applying the laser 108B to the gap 306, the gap 306 may be filled with the overlap cladding layer 310. The overlap cladding layer 310 extends the gap 306 and also overlaps at least a portion of the cladding layer 304. As such, an empty space between the overlap cladding layer 310 and the corresponding clad ends 308A, 308B of the cladding layer 304 may be reduced. Moreover, by applying the laser 108B to the gap 306 and the clad ends 308A, 308B at step 206, defects may be reduced in the overlap cladding layer 310. Further, such method 200 may be implemented by the controller 118 automatically with minimal manual intervention.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for applying a cladding layer to a substrate, comprising:
applying a cladding layer from a start position using a laser operating in a continuous mode of operation;
completing the cladding layer at a stop position in close proximity to the start position, the area between the start position and the stop position defining a gap;
applying the laser directly to at least the gap while operating in a pulse mode of operation; and
filling the gap with an overlap cladding layer using the laser operating in the continuous mode of operation.

2. The method of claim 1 further comprising supplying a shielding gas to the substrate.

3. The method of claim 1, wherein applying the cladding layer comprises dispensing a cladding material on the substrate.

4. The method of claim 1 further comprising applying the laser directly to clad ends of the cladding layer while operating in the pulse mode of operation.

5. The method of claim 1, wherein the overlap cladding layer overlaps at least a portion of the cladding layer.

6. The method of claim 1, wherein the substrate has an annular shape.

7. The method of claim 6, wherein an angle subtended by the cladding layer with a center of the substrate is in a range of 350 to 359 degrees.

8. The method of claim 6, wherein an angle subtended by the overlap cladding layer with a center of the substrate is in a range of 2 to 12 degrees.

9. A computer-implemented method for laser cladding a substrate, the method comprising:
applying a cladding layer from a start position using a laser operating in a continuous mode of operation;
completing the cladding layer at a stop position in close proximity to the start position, the area between the start position and the stop position defining a gap;
applying the laser directly to at least the gap while operating in a pulse mode of operation; and
filling the gap with an overlap cladding layer using the laser operating in the continuous mode of operation.

10. The computer-implemented method of claim 9 further comprising supplying a shielding gas to the substrate.

11. The computer-implemented method of claim 9, wherein applying the cladding layer comprises dispensing a cladding material on the substrate.

12. The computer-implemented method of claim 9 further comprising applying the laser directly to clad ends of the cladding material while operating the laser in pulse mode of operation.

13. The computer-implemented method of claim 9, wherein the overlap cladding layer overlaps at least a portion of the cladding layer.

14. The computer-implemented method of claim 9, wherein the substrate has an annular shape.

15. The computer-implemented method of claim 14, wherein an angle subtended by the cladding layer with a center of the substrate is in a range of 350 to 359 degrees.

16. The computer-implemented method of claim 14, wherein an angle subtended by the overlap cladding layer with a center of the substrate is in a range of 2 to 12 degrees.

17. A system configured to apply a cladding layer to a substrate, the system comprising:
a laser head configured to generate a laser;
a dispensing apparatus configured to dispense a cladding material; and
a controller communicably coupled to the laser head and the dispensing apparatus, the controller configured to:
apply a cladding layer from a start position using the laser operating in a continuous mode of operation;
complete the cladding layer at a stop position in close proximity to the start position, the area between the start position and the stop position defining a gap;
apply the laser directly to at least the gap while operating in a pulse mode of operation; and
fill the gap with an overlap cladding layer using the laser operating in the continuous mode of operation.

18. The system of claim 17 further comprising a nozzle configured to supply a shielding gas to the substrate.

19. The system of claim 17, wherein applying the cladding layer to the substrate comprises dispensing the cladding material from the dispensing apparatus to the substrate.

20. The system of claim 17, wherein the substrate has an annular shape.
